(19) United States
(12) Patent Application Publication
(10) Pub. No.: US 2015/0045161 A1
(43) Pub. Date: Feb. 12, 2015

(54) Cellulose Acetate Table Tennis Balls and Processes for Making

(71) Applicant: Celanese International Corporation, Irving, TX (US)

(72) Inventors: Zeming Gou, Blacksburg, VA (US); Jiawei Li, Shanghai (CN); Rongfu Li, Blacksburg, VA (US); Kevin Pan, Irving, TX (US); Naresh Budhavaram, Blacksburg, VA (US); Michael T. Combs, Shady Spring, WV (US); Yu Gao, Shanghai (CN)

(21) Appl. No.: 14/452,735

(22) Filed: Aug. 6, 2014

Related U.S. Application Data
(60) Provisional application No. 61/862,571, filed on Aug. 6, 2013.

(51) Int. Cl. A63B 45/00; B29C 65/00; B29C 47/00; A63B 39/00; B29C 51/26

(52) U.S. Cl. CPC A63B 45/00; A63B 39/00; B29C 51/264; B29C 47/0021; B29C 66/54; B29C 47/0066; B29K 2001/12
USPC 473/609; 156/244.13

(57) ABSTRACT

The present invention is directed to cellulose acetate table tennis balls and to processes for forming the cellulose acetate table tennis balls. Cellulose acetate may be provided as a flake or powder and then may be melt extruded to a sheet or pellet. The sheet may be soaked and a plurality of coupons may then be cut from the sheet. The coupons may be melt extruded to form hemispheres and then two hemispheres may be adhered to each other to form a sphere. The pellets may be injection molded to form hemispheres and then two hemispheres may be adhered to each other to form a sphere. The cellulose acetate table tennis balls are free of celluloid but meet the International Table Tennis Federation standards for table tennis balls.

### CROSS-REFERENCE TO RELATED APPLICATION

This application claims priority to U.S. Provisional App. No. 61/862,571, filed on Aug. 6, 2013, the entirety of which is incorporated herein by reference.

### FIELD OF THE INVENTION

The present invention relates generally to table tennis balls and the processes for making table tennis balls. In particular, the present invention relates to table tennis balls comprising cellulose acetate and plasticizer. The cellulose acetate table tennis balls may be formed by thermoforming or by injection molding.

### BACKGROUND OF THE INVENTION

Table tennis balls are typically manufactured using cellulose nitrate, also referred to as celluloid. Generally, celluloid table tennis balls comprise from 70 to 80 parts nitrocellulose (nitrated to 11% nitrogen), approximately 30 parts camphor, from 0 to 14 parts dye, from 1 to 5 parts ethyl alcohol, and other stabilizers and additives to increase stability and reduce flammability. U.S. Pat. No. 2,091,684 describes a hollow table tennis ball made of relatively thin flexible celluloid or similar materials. However, celluloid is highly flammable and also decomposes easily. Celluloid manufacturing processes also require the use of numerous solvents that pose an explosion hazard.

In addition, celluloid manufacturing processes involve numerous steps requiring extended manufacturing time, e.g., up to 110 days. Manufacturing steps include soaking celluloid chips in an alcohol/water mixture for 10 days, forming hemispheres from the chips, cutting the hemispheres and checking thickness, adhering hemispheres with adhesive and drying for 5 days, checking the weight of the balls and drying for an additional 60 days, sanding, polishing and washing the balls, thermal forming through a metal mold, sanding and polishing, and running quality control tests.

Because of these limitations, attempts have been made to prepare non-celluloid table tennis balls that satisfy International Table Tennis Federation (“ITTF”) specifications. These specifications include a diameter between 39.5 and 40.5 millimeters (mm), a weight between 2.67 and 2.77 grams, a hardness at the poles of 0.68 to 0.81 mm, a hardness at the seam from 0.72 to 0.83 mm, a bounce when dropped from 305 mm of 240 to 260 mm, and a color of white or orange, with a matte finish. Additional considerations include mechanical properties such as complete and invisible recovery of deformations within a few milliseconds; lack of stress-whitening and other, irreversible material changes under load; stability at impact on a rubber coated surface with a relative speed of up to 250 km/h; stability at impact on a stiff, coated surface with a relative speed of up to 120 km/h; breaking strength of material and possible seam by 5000-fold repeated impact at described contact settings; and stability at rotations up to 180 revolutions per second.

U.S. Pat. No. 8,105,183 describes a celluloid-free table tennis ball having a principal component that is an organic non-crosslinked polymer, which in its main chain has not only carbon atoms but also heteroatoms. The organic non-crosslinked polymer may be selected from the group consisting of Polyoxymethylene (POM), polybutylene terephthalate (PBT), polyethylene terephthalate (PET), polysulphone (PSU), polyether imide (PEI), polyetherether ketone (PEEK), polyethylene naphthalate (PEN), polybutylene naphthalate (PBN), polytrimethylene terephthalate (PTT), and a copolymer of one of the substances. Another attempt to make a non-celluloid table tennis ball is described in GB Patent No. 1222901, which uses a styrene-acrylnitrile-acrylic elastomer. CN Pat. App. No. 102838782A describes preparing a cellulose acetate table tennis ball by mixing the raw materials in a high-speed mixer, extruding the mixed raw materials using a twin-screw extruder, and making the extruded raw materials into sheets using a coat-hanger die. A three-roller plating press is used to adjust the thickness, and after cold drawing, the material is cut into sheets of a length and thickness meeting the requirements of table tennis ball manufacturing.

Despite these attempts at produce celluloid-free table tennis balls, the need exists for table tennis balls that do not employ celluloid and that achieve the ITTF specifications for table tennis balls. In particular, the need exists for celluloid-free table tennis balls and processes for preparing celluloid-free table tennis balls that: 1) reduce the number of solvents used in manufacturing; 2) reduce the explosion hazard during manufacture; 3) reduce flammability; 4) reduce manufacturing time; and 5) achieve the ITTS specifications.

### SUMMARY OF THE INVENTION

In a first embodiment, the present invention is directed to a process for manufacturing table tennis balls, comprising: (a) mixing cellulose acetate and a plasticizer to form a mixture; (b) melt extruding the mixture in a film die to form an extruded sheet; (c) soaking the extruded sheet in a solvent to form a soaked sheet; (d) cutting a plurality of coupons from the soaked sheet; (e) thermoforming the coupons into hemispheres; and (f) adhering pairs of hemispheres to form the table tennis balls. The solvent may be selected from the group consisting of water, alcohols, and combinations thereof. The plasticizer may be selected from the group consisting of triacetin, tributyl citrate, triethyl citrate, dimethyl phthalate, diethyl phthalate, bornan-2-one (camphor), PEG-DGE, PPG-DGE, tributyl phosphate, and combinations thereof. The mixture may further comprise an antioxidant selected from the group consisting of stearyl 3-(3,5-di-tert-butyl-4-hydroxyphenyl)propionate, bis(2,4-dicumylphenyl)pentaerythritol diphosphite, tris(2,4-di-tert-butylphenyl)phosphite, bisphenol A propoxylate diglycidyl ether, 9,10-dihydroxy-9-oxa-10-phosphaphenanthrene-10-oxide, and combinations thereof. The mixture may further comprise a lubricant selected from the group consisting of epoxidized soybean oil, epoxidized polypropylene oxide, epoxidized PPO-PEO, and combinations thereof. The mixing step may comprise mixing one or more additives in addition to the cellulose acetate and the plasticizer to form the mixture. For example, in one aspect, the mixture may further comprise a colorant selected from the group consisting of titanium oxide, barium sulfate, iron oxide, nickel titanate, benzimidazolone orange g1, solvent orange 60, orange dyes, a combination of red and yellow dyes, and combinations thereof. In some embodiments, the mixture may be formed by mixing cellulose acetate flake with the plasticizer in a high speed mixer optionally with one or more additives. In other embodiments, the mixture may be formed by mixing cellulose acetate powder with the plasticizer in a high speed mixer optionally with one or more additives. The melt extruding may be performed at a temperature less than or equal to 220° C. The mixture may comprise from 60 to 75 wt. % cellulose acetate and from 25 to 35 wt. % plasticizer. The cellulose acetate may have a degree of substitution from 2.1 to 2.9. The cellulose acetate may have a molecular weight from 40,000 to 80,000. The sheet may be soaked in water for 1 to 24 hours.

In a second embodiment, the present invention is directed to a process for manufacturing table tennis balls, comprising: (a) providing pellets comprising cellulose acetate, a plasticizer, and optionally one or more additives; (b) injection molding the pellets into a die to form hemispheres; and (c) adhering pairs of hemispheres to form the table tennis balls; wherein the pellets are formed by melt extrusion or solvent casting. The plasticizer may be selected from the group consisting of triacetin, tributyl citrate, triethyl citrate, dimethyl phthalate, diethyl phthalate, bornan-2-one, PEG-DGE, PPG-DGE, tributyl phosphate, and combinations thereof. The mixture may further comprise an antioxidant selected from the group consisting of stearyl 3-(3,5-di-tert-butyl-4-hydroxyphenyl)propionate, bis(2,4-dicumylphenyl)pentaerythritol diphosphite, tris(2,4-di-tert-butylphenyl)phosphite, bisphenol A propoxylate diglycidyl ether, 9,10-dihydroxy-9-oxa-10-phosphaphenanthrene-10-oxide, and combinations thereof. The mixture may further comprise a lubricant selected from the group consisting of epoxidized soybean oil, epoxidized polypropylene oxide, epoxidized PPO-PEO, and combinations thereof. The mixture may further comprise a colorant selected from the group consisting of titanium oxide, barium sulfate, iron oxide, nickel titanate, benzimidazolone orange g1, solvent orange 60, orange dyes, a combination of red and yellow dyes, and combinations thereof. In one embodiment, the mixture may be formed by mixing cellulose acetate flake with the plasticizer in a high speed mixer optionally with one or more additives. In another embodiment, the mixture may be formed by mixing cellulose acetate powder with the plasticizer in a high speed mixer optionally with one or more additives. The process may further comprise the steps of mixing the cellulose acetate, the plasticizer and optional additives to form a compounded material; and melt extruding the compounded material to form the pellets. The melt extruding may be performed at a temperature no greater than 220° C. The pellets may comprise from 0 to 75 wt. % cellulose acetate and from 25 to 35 wt. % plasticizer. The cellulose acetate may have a degree of substitution from 2.1 to 2.9. The cellulose acetate may have a molecular weight from 40,000 amu to 80,000 amu.

In a third embodiment, the present invention is directed to melt extruding and thermoforming a mixture to form a table tennis ball, the mixture comprising cellulose acetate having a degree of substitution from 2.1 to 2.9, a plasticizer, and optionally one or more additives.

In a fourth embodiment, the present invention is directed to solvent casting and thermoforming a mixture to form a table tennis ball, the mixture comprising cellulose acetate having a degree of substitution from 2.1 to 2.9, a plasticizer, and optionally one or more additives.

In a fifth embodiment, the present invention is directed to melt extruding and injection molding a mixture to form a table tennis ball, the mixture comprising cellulose acetate having a degree of substitution from 2.1 to 2.9, a plasticizer, and optionally one or more additives.

### BRIEF DESCRIPTION OF THE DRAWING

The present invention will be better understood in view of the appended non-limiting FIGURE, in which:

FIG. 1 shows plasticizer migration for examples prepared in accordance with an embodiment of the invention.

### DETAILED DESCRIPTION OF THE INVENTION

### I. Introduction

The present invention relates to cellulose acetate table tennis balls and to processes for manufacturing cellulose acetate table tennis balls. The cellulose acetate table tennis balls are free of celluloid. The process for manufacturing the cellulose acetate table tennis balls may employ a thermoforming process or an injection molding process. In embodiments wherein a thermoforming process is utilized, the cellulose acetate table tennis balls may be manufactured by mixing cellulose acetate and a plasticizer to form a mixture, melt extruding the mixture in a film die to form an extruded sheet, soaking the extruded sheet in a solvent to form a soaked sheet, cutting a plurality of coupons from the soaked sheet, thermoforming the coupons into hemispheres, and adhering pairs of hemispheres to form the table tennis balls. In some embodiments, the mixture may be solution cast instead of melt extruded.

In embodiments wherein an injection molding process is utilized, the cellulose acetate table tennis balls may be manufactured by providing pellets comprising cellulose acetate, a plasticizer and optionally one or more additives, injecting molding the pellets into a die to form hemispheres, and adhering pairs of hemispheres to form the table tennis balls. The pellets may be prepared substantially as the extruded sheet is prepared (as described above), except that a capillary die and pelletizer are used instead of a film die.

The use of the above processes results in cellulose acetate table tennis balls that are advantageously free of celluloid. In addition, the processes may: 1) reduce the number of solvents used in manufacturing the table tennis balls; 2) reduce the explosion hazard during manufacture of the table tennis balls; 3) reduce the flammability of the table tennis balls; 4) reduce the manufacturing time period; and/or 5) achieve the ITTF specifications for the table tennis balls.

### II. Cellulose Acetate

Cellulose is generally known to be a semi-synthetic polymer containing anhydroglucose repeating units with three hydroxyl groups per anhydroglucose unit. Cellulose acetate may be formed by esterifying cellulose after activating the cellulose with acetic acid. The cellulose may be obtained from numerous types of cellulosic material, including but not limited to plant derived biomass, corn stover, sugar cane stalk, bagasse and cane residues, rice and wheat straw, agricultural grasses, hard wood, hardwood pulp, soft wood, softwood pulp, herbs, recycled paper, waste paper, wood chips, pulp and paper wastes, waste wood, thinned wood, cornstalk, chaff, and other forms of wood, bamboo, soyhull, bast fibers, such as kenaf, hemp, jute and flax, agricultural residual products, agricultural wastes, excretions of livestock, microbial, algal cellulose, seaweed and all other materials proximately or ultimately derived from plants. Such cellulosic raw materials are preferably processed in pellet, chip, clip, sheet, attritioned fiber, powder form, or other form rendering them suitable for further purification.

The cellulose acetate used to form the cellulose acetate table tennis balls may be cellulose diacetate or cellulose triacetate. Cellulose acetate has an acetyl value, which is a measure of the degree of substitution of the cellulose acetate. The acetyl value represents the weight percent of acetic acid liberated by the saponification of cellulose acetate. The acetyl value and degree of substitution are linearly related. The degree of substitution may be calculated from the acetyl value according to the following formula:

$$Degree of substitution = \frac{Acetyl value \times 162}{6005 - ( Acetyl value \times 42 )}$$

In the processes of the invention for making table tennis balls, various solvents may be used as adhering agents to bond opposing cellulose acetate hemispheres together. The solubility and, hence, bonding ability of cellulose acetate in a solvent depends, at least in part, on the acetyl value of the cellulose acetate. As the acetyl value decreases, solubility of the cellulose acetate may improve in ketones, esters, nitrogen-containing compounds, glycols and ethers. As the acetyl value increases, solubility of the cellulose acetate may improve in halogenated hydrocarbons. As a result, the acetyl value and degree of substitution of the cellulose acetate employed as well as the desired solvent for bonding may impact the ability to form durable and mechanically uniform table tennis balls. In some exemplary embodiments, the cellulose acetate employed in the present invention may have a degree of substitution from 2.1 to 2.9, e.g., from 2.2 to 2.7 or of approximately 2.5. The corresponding acetyl value may range from 50% to 62%, e.g., from 52% to 59% or approximately 56%.

The number average molecular weight of the cellulose acetate may range from 40,000 amu to 100,000 amu, e.g., from 50,000 amu to 80,000 amu. The cellulose acetate may be provided in powder or flake form. The powder form of cellulose acetate may have an average particle size from 200 to 300 μm, as determined by sieve analysis. In some embodiments, at least 90% of the particles may have a diameter of less than 400 μm, at least 50% of the particles may have a diameter of less than 200 μm, and at least 10% of the particles may have a diameter of less than 70 μm.

The flake form of cellulose acetate may have an average flake size from 5 μm to 10 mm, as determined by sieve analysis. The flake form may have less than 3 wt. % moisture, e.g., less than 2.5 wt. % moisture. In terms of ranges, the flake form may have from 0.01 to 3 wt. % moisture, e.g., from 0.1 to 2.5 wt. % moisture or from 0.5 to 2.45 wt. % moisture. Prior to mixing, the cellulose acetate flake may be heated to remove moisture. In some embodiments, the cellulose acetate flake may be dried until it has a moisture content of less than 2 wt. % moisture, e.g., less than 1.5 wt. %, less than 1 wt. % or less than 0.2 wt. %, The drying may be conducted at a temperature from 30 to 100° C., e.g., from 50 to 80° C. and for a period of 1 to 24 hours, e.g., from 5 to 20 hours or from 10 to 15 hours.

### III. Preparation of Cellulose Acetate Sheets and Pellets

As described above, cellulose acetate may be formed into sheets or pellets prior to being subjected to thermoforming or injection molding to form the table tennis balls. In one embodiment, to form the cellulose acetate sheet or pellet, the cellulose acetate may be melt extruded using the appropriate die to form the sheet or pellet. In one embodiment, the sheets and pellets may be prepared via casting methods, such as solvent casting.

As described in U.S. Pat. No. 7,083,752, the entirety of which is incorporated herein by reference, melt extrusion methods may involve heating the resin until molten (approximate viscosity on the order of 100,000 cp), and then applying the hot molten polymer to a highly polished metal band or drum with an extrusion die, cooling the sheet, and finally peeling the sheet or pellet from the metal support. However, melt extrusion of cellulose acetate is limited by the melting temperature of cellulose acetate, e.g., from 230-300° C., because degradation of the cellulose acetate may occur at temperatures of 230° C. and above.

One method to reduce the melting temperature of the cellulose acetate is to form a mixture comprising a plasticizer and the cellulose acetate prior to melt extrusion or solvent casting . In some embodiments, at least one additive may also be mixed with the plasticizer and cellulose acetate to form the mixture. The cellulose acetate may be present in an amount from 60 to 90 wt. % of the mixture, e.g., from 70 to 85 wt. %. Weight percentages are based on the total weight of the mixture, which includes the weight of the cellulose acetate, the plasticizer, and any additives included in the mixture. As noted above, the cellulose acetate may be provided as a flake or as a powder.

The plasticizer optionally may be selected from the group consisting of triacetin, triethyl citrate, diethyl phthalate, dimethyl phthalate, tributyl citrate, bornan-2-one, poly(ethylene glycol) diglycidyl ether (PEG-DGE), poly(propylene glycol) diglycidyl ether (PPG-DGE), tributyl phosphate and mixtures thereof, and may be present in an amount from 20 to 35 wt. %, based on the total weight of the mixture, e.g., from 25 to 32 wt. % or from 28 to 30 wt. %.

The at least one additive that is optionally included in the mixture may include antioxidants, colorants (dyes and pigments), lubricants, or any other known additive. The antioxidant may be selected from the group consisting of stearyl 3-(3,5-di-tert-butyl-4-hydroxyphenyl)propionate, bis(2,4-dicumylphenyl)pentaerythritol diphosphite, tris(2,4-di-tert-butylphenyl)phosphite, bisphenol A propoxylate diglycidyl ether, 9,10-dihydroxy-9-oxa-10-phosphaphenanthrene-10-oxide and combinations thereof. The antioxidant may be present in an amount from 0.01 to 10 wt. %, based on the total weight of the mixture, e.g., from 0.03 to 2 wt. %, or from 0.1 to 1 wt. %. The colorant may be selected from the group consisting of titanium oxide, barium sulfate, iron oxide, nickel titanate, benzimidazolone orange gl, solvent orange 60, orange dyes, a combination of red and yellow dyes, and combinations thereof, and may be present in an amount from 0.1 to 5 wt. %, based on the total weight of the mixture, e.g., from 0.5 to 2 wt. %. The lubricant may be selected from the group consisting of epoxidized soybean oil, epoxidized polypropylene oxide, epoxidized poly(propylene oxide)-poly(ethylene oxide) (PPO-PEO), and combinations thereof. The lubricant may be present in an amount from 0.1 to 10 wt. %, based on the total weight of the mixture, e.g., from 1 to 3 wt. %. Other known additives may be present in an amount less than 1 wt. %, based on the total weight of the mixture. Regardless of the additives included, the total amount of additives is preferably less than or equal to 10 wt. %, based on the total weight of the mixture.

The mixture may be formed by combining cellulose acetate, in flake or powder form, with plasticizer in a high speed mixer. In some embodiments, the plasticizer may be combined with the cellulose acetate using a spray distribution system during the mixing step. In other embodiments, the plasticizer may be added to the cellulose acetate during the mixing step, either continuously or intermittently. In some embodiments, the powder form of cellulose acetate is preferred. Without being bound by theory, it is believed that the powder form may lead to a sheet with improved plasticization and uniformity. If included in the mixture, the additives may be combined with the cellulose acetate and plasticizer during the mixing step. In some embodiments, the high speed mixer may be may be operated for 1 to 2 minutes.

In one embodiment, after forming the mixture comprising cellulose acetate, plasticizer, and optional additives, the mixture may be melt extruded in a film die to form a sheet or melt extruded in a small hole die to form filaments which are then sent to a pelletizer to form pellets. The melt extrusion may be performed at a temperature of up to 230° C., e.g., up to 220° C. or up to 210° C. A temperature above 230° C. may lead to destabilization of the mixture components, particularly of the cellulose acetate. The melt extruder may be a twin screw feeder with co-rotating screws, and may be operated at a screw speed from 100 to 500 rpm, e.g., from 150 to 450 rpm, or from 250 to 350 rpm. The sheet may have a thickness between 0.5 and 0.6 mm, e.g., from 0.53 to 0.54 mm.

In another embodiment, the mixture may be solution cast. In this process, the cellulose acetate is generally used in flake form. The cellulose acetate may then be dissolved in acetone to form an acetone dope. Additional components, including the plasticizers disclosed herein may be included with the acetone dope. The acetone dope may also comprise one or more of titania, silica, anti-blocking agents, stearic acid, dyes and/or one or more specialty chemicals. The components are then mixed as described above. The resultant mixture may then be filtered. The mixture then may be cast into a continuous film by die extrusion. The film may be dried in a warm air drying cabinet comprising rollers.

### IV. Thermoforming Hemispheres and Table Tennis Balls

In one embodiment, the table tennis balls may be formed by thermoforming of an extruded sheet comprising cellulose acetate, plasticizer, and optional additives. The extruded sheet, which may be formed as disclosed above, may then be soaked, e.g., in water, to reduce residual stress in the sheet. Without being bound by theory, the residual stress in the sheet may be due to the melt extrusion process used to form the sheet. The temperature of the water may be from 30 to 70° C., e.g., from 40 to 60° C., or approximately 50° C. The extruded sheet may be soaked for at least 15 hours, e.g., at least 20 hours or at least 30 hours. In terms of ranges, the extruded sheet may be soaked for 1-15 hours, e.g., from 5 to 20 hours or from 10 to 30 hours.

After soaking, the process may further comprise cutting a plurality of coupons from the resulting soaked sheet. Each coupon may have a diameter from 50 to 60 mm, e.g., approximately 55 mm and a thickness from 0.5 to 0.6 mm, e.g., from 0.53 to 0.54 mm.

Each coupon may then be thermoformed into a hemisphere. The hemispheres comprise one layer of coupon, the layer preferably having a thickness of from 40 to 50 μm. The thermoforming process may be conducted at a temperature from 80-90° C. and the process may be conducted in water.

Each hemisphere may then be adhered to another hemisphere to form a sphere, e.g., table tennis ball. A hemisphere may be adhered to another hemisphere using an adhesive or bonding agent. The resulting sphere is then polished to smooth any edges and seals, and is allowed to settle at room temperature for 3 to 5 days. The adhesive may comprise a combination of butyl acetate and acetone, present in a molar ratio of from 60:40 to 80:20, or approximately 70:30. The bonding agent may be selected from the group consisting of ethyl lactate, diethyl phthalate, water-based acrylics, polyurethanes, hot melts, and combinations thereof.

The thermoforming process may advantageously reduce production time of table tennis balls by at least 66%, e.g., by 40 to 50 days, as compared to the celluloid manufacturing process.

### V. Injection Molding

In one embodiment, the hemispheres, and the table tennis balls formed therefrom, are formed by injection molding. The pellets, each of which comprises cellulose acetate, plasticizer, and one or more optional additives, are used in the injection molding process. Prior to injection molding of the pellets, the pellets may be dried, e.g., in an oven, to remove residual moisture.

The injection molding process used to form the hemispheres from the cellulose acetate pellets may, in some embodiments, be similar to the process used to form celluloid hemispheres, as described by Joel R. Fried, Polymer Science & Technology, Second Edition, p. 432-433, 2003, the entirety of which is incorporated herein by reference. The injection molding process may include, for example, a drying step at 60° C. to 80° C. for approximately 4 hours and a melting step from 180° C. to 220° C. In some embodiments, the melting step may comprise multiple melt temperature heat zones, e.g., two zones, three zones or four zones. The temperature may decrease through each zone. The injection time may range from 1 to 20 seconds, e.g., from 1 to 15 seconds, from 1 to 10 seconds, or from 1 to 5 seconds. The mold temperature may range from 30 to 70° C., e.g., from 40 to 60° C. or from 45 to 50° C. The overall cycle time may range from 10 to 40 seconds, e.g., from 15 to 30 seconds or from 20 to 25 seconds.

In some embodiments, after forming hemispheres by injection molding, each hemisphere may then be adhered to another hemisphere to form a sphere, e.g., a table tennis ball. A hemisphere may be adhered to another hemisphere as described above. The injection molding process advantageously may be completed in a short amount of time, e.g., a cycle time of 5 to 10 seconds. In some embodiments, the injection molding process may be at least 50% shorter than the thermoforming process discussed herein, e.g., at least 60% shorter or at least 65% shorter.

The present invention will be better understood in view of the following non-limiting examples.

### VI. EXAMPLES

### Comparative Example A

The properties of a typical celluloid table tennis ball, as reported by Emilila R. Inone-Kauffmann, Spezialkunststoffe, Eigenschaftern and Anwendungen, Springer, Berline Heidelberg (2008), Chapter 4, Table 4-10, the entirety of which is incorporated herein by reference, are shown in Table 1.

TABLE 1
CELLULOID TABLE TENNIS BALL PROPERTIES

| Property | Value | |
|---|---|---|
| Density | 1.38 | g/cm³ |
| Tensile Strength | 40 to 60 | MPa |
| Elongation | 30 to 50% | |
| Flexural Modulus | 2500 | MPa |
| Compressive Strength | 60 | MPa |
| Hardness | 60 to 90 | MPa |
| Notched Impact Strength | 20 to 30 | KJ/m² |
| Melting Temperature | 110° | C. |
| Ignition Temperature | 180° | C. |

### Example 1

Cellulose acetate films were cast using solvent casting. Eight samples, designated Films A-H, were prepared by weighing out the components in accordance with the amounts listed in Table 2 and placing the weighed samples in a high-density polyethylene bottle, followed by sealing the bottle and rolling the bottle overnight. The cellulose acetate was completely dissolved in acetone forming a cellulose acetate dope. The dope also comprised other ingredients well dispersed therein. The cellulose acetate dope was then cast onto a glass substrate with dimensions of approximately 53 cm by approximately 30 cm with a Gardco Automatic drawdown machine II at a stroke length of approximately 46 cm and a speed setting of 5.08 cm/second. The gap between the film casting bar and the glass substrate was adjusted, e.g., from approximately 0.45 to 0.60 mm, such that the resultant dry film had a thickness of approximately 100 μm. The cast film was left in the chemical hood to dry overnight. The dry film was then cut into 2.54 cm by 20.32 cm or 25.4 cm specimens by a Qualitest DT-1010 film cutter. At least seven specimens were prepared from each film formulation. The specimens from each sample were then conditioned at a temperature of 23° C. ±2° C. and at a humidity of 50%±10%. The specimens were then tested per ASTM D882-10 in a controlled mechanical testing lab. The film compositions are shown in Table 2.

TABLE 2
FILM COMPOSITIONS

| | CA Flake | Triacetin | Acetone | Water | Silica | Stearic | PEG-DGE |
|---|---|---|---|---|---|---|---|
| | (g) | (g) | (g) | (g) | (g) | Acid (g) | (g) |
| Film A | 72.5 | 17.4 | 275 | 1.5 | 0.275 | 0.055 | — |
| Film B | 72.5 | 21.75 | 275 | 1.5 | 0.275 | 0.055 | — |
| Film C | 72.5 | 25.3 | 275 | 1.5 | 0.275 | 0.055 | — |
| Film D | 72.5 | 12 | 275 | 1.5 | 0.275 | 0.055 | 13.3 |
| Film E | 72.5 | 0 | 275 | 1.5 | 0.275 | 0.055 | 17.4 |
| Film F | 72.5 | 0 | 275 | 1.5 | 0.275 | 0.055 | 21.75 |
| Film G | 72.5 | 0 | 275 | 1.5 | 0.275 | 0.055 | 25.3 |
| Film H | 72.5 | 17.4 | 275 | 1.5 | 0.275 | 0.055 | 7.9 |

The viscosity of the cellulose acetate dope was tested at room temperature by using a Brookfield programmable DV-II+ viscometer with the selection of spindle #6, and two rotation speeds 50 and 100 rpm. The stress at break, strain at break and modulus of the dry film samples were then tested by using Instron 3366 per ASTM D882-10. The 2.54 cm by 2.54 cm rubber coated faces on the 90.71 kg capacity pneumatic side action grips were used in the test. The results are shown below in Table 3.

TABLE 3
FILM PROPERTIES

| | Film A | Film B | Film C | Film D | Film E | Film F | Film G | Film H |
|---|---|---|---|---|---|---|---|---|
| Viscosity at | 24107 | 23200 | 24267 | 22880 | 23840 | 26507 | 23893 | 24640 |
| 50 rpm | | | | | | | | |
| (mPa.s) | | | | | | | | |
| Viscosity at | 33800 | 21973 | 22560 | 21440 | 22800 | 24187 | 21707 | 22427 |
| 100 RPM | | | | | | | | |
| Stress at | 44.6 | 39.74 | 36.01 | 34.54 | 39.21 | 36.2 | 34.69 | 33.33 |
| Break Max | | | | | | | | |
| (MPA) | | | | | | | | |
| Stress at | 33.88 | 29.27 | 27 | 26.77 | 33.22 | 28.7 | 28.52 | 25.39 |
| Break Min | | | | | | | | |
| (MPA) | | | | | | | | |
| Stress at | 39.94 | 36.96 | 31.03 | 30.42 | 35.28 | 31.4 | 30.78 | 29.06 |
| Break | | | | | | | | |
| (MPA) | | | | | | | | |
| Strain at | 0.185 | 0.19 | 0.23 | 0.25 | 0.21 | 0.22 | 0.29 | 0.23 |
| Break | | | | | | | | |
| Max (%) | | | | | | | | |
| Strain at | 0.089 | 0.087 | 0.072 | 0.11 | 0.091 | 0.129 | 0.22 | 0.126 |
| Break | | | | | | | | |
| Min (%) | | | | | | | | |
| Strain at | 0.131 | 0.141 | 0.152 | 0.2 | 0.131 | 0.166 | 0.258 | 0.18 |
| Break (%) | | | | | | | | |
| Modulus | 1756 | 1750 | 1363 | 1423 | 1645 | 1510 | 1220 | 1238 |
| Max (MPa) | | | | | | | | |
| Modulus | 1482 | 1330 | 1202 | 1043 | 1521 | 1244 | 998 | 1020 |
| Min (MPa) | | | | | | | | |
| Modulus | 1650 | 1573 | 1292 | 1186 | 1571 | 1352 | 1124 | 1149 |
| (MPa) | | | | | | | | |

### Example 2

Five films, designated Films I-N, were formed as explained in Example 1, but with varied amounts of triacetin (plasticizer) as shown in Table 4.

TABLE 4
FILM COMPOSITIONS

| | CA | Triacetin | Triacetin | Acetone | Water | Silica | Stearic |
|---|---|---|---|---|---|---|---|
| | Flake (g) | (g) | (wt. %) | (g) | (g) | (g) | Acid (g) |
| Film I | 72.5 | 12 | 17 | 275 | 1.5 | 0.275 | 0.055 |
| Film J | 72.5 | 14 | 20 | 275 | 1.5 | 0.275 | 0.055 |
| Film K | 72.5 | 17 | 25 | 275 | 1.5 | 0.275 | 0.055 |
| Film L | 72.5 | 19.5 | 30 | 275 | 1.5 | 0.275 | 0.055 |
| Film M | 72.5 | 21.9 | 35 | 275 | 1.5 | 0.275 | 0.055 |
| Film N | 72.5 | 24.1 | 40 | 275 | 1.5 | 0.275 | 0.055 |

The films were then tested by Instron 3366 per ASTM D882-10. The results are shown in Table 5.

TABLE 5
FILM PROPERTIES

| | Film I | Film J | Film K | Film L | Film M | Film N |
|---|---|---|---|---|---|---|
| Stress at Break | 47.29 | 54.51 | 50.74 | 62.1 | 53.24 | 39.17 |
| Max (MPA) | | | | | | |
| Stress at Break | 43.41 | 44.55 | 40.65 | 26.09 | 27.39 | 24.82 |
| Min (MPA) | | | | | | |
| Stress at Break | 45.86 | 50.1 | 46.8 | 42.38 | 36.1 | 31.6 |
| (MPA) | | | | | | |
| Strain at Break | 17 | 26 | 25 | 37 | 29 | 37 |
| Max (%) | | | | | | |
| Strain at Break | 9 | 13 | 12 | 13 | 6 | 19 |
| Min (%) | | | | | | |
| Strain at Break | 12 | 20 | 21 | 26 | 20 | 23 |
| (%) | | | | | | |
| Modulus Max | 2094 | 2103 | 2008 | 2150 | 1804 | 1321 |
| (MPa) | | | | | | |
| Modulus Min | 1878 | 1887 | 1548 | 1077 | 1091 | 887 |
| (MPa) | | | | | | |
| Modulus | 1981 | 2018 | 1751 | 1554 | 1348 | 1160 |
| (MPa) | | | | | | |

### Example 3

Several films, designated Films O-V, were formed as explained in Example 1, but with varied plasticizers as shown in Table 6.

TABLE 6
FILM COMPOSITIONS

| | CA | | | | | | |
|---|---|---|---|---|---|---|---|
| | Flake | | Plasticizer | Acetone | Water | Silica | Stearic |
| | (g) | Plasticizer | (g) | (g) | (g) | (g) | Acid (g) |
| Film O | 72.5 | Epoxidized | 17 | 275 | 1.5 | 0.275 | 0.055 |
| | | soybean oil | | | | | |
| Film P | 72.5 | Triacetin | 17 | 275 | 1.5 | 0.275 | 0.055 |
| Film Q | 72.5 | PEG-DGE | 17 | 275 | 1.5 | 0.275 | 0.055 |
| Film R | 72.5 | PPG-DGE | 17 | 275 | 1.5 | 0.275 | 0.055 |
| Film S | 72.5 | Tributyl | 17 | 275 | 1.5 | 0.275 | 0.055 |
| | | phosphate | | | | | |
| Film T | 72.5 | — | — | 275 | 1.5 | 0.275 | 0.055 |
| Film U | 72.5 | — | — | 275 | 1.5 | — | 0.055 |
| Film V | 72.5 | — | — | 275 | — | — | 0.055 |

The films were then tested by Instron 3366 per ASTM D882-10. The results are shown in Table 7.

TABLE 7
FILM PROPERTIES

| | Film O | Film P | Film Q | Film R | Film S | Film T | Film U | Film V |
|---|---|---|---|---|---|---|---|---|
| Stress at Break | 55.47 | 56.28 | 54.44 | 47.61 | 57.48 | 63.81 | 69.75 | 62.36 |
| Max (MPA) | | | | | | | | |
| Stress at Break | 46.18 | 47.5 | 42.56 | 39.02 | 43.62 | 56.85 | 59.17 | 43.81 |
| Min (MPA) | | | | | | | | |
| Stress at Break | 50.9 | 51.1 | 47.8 | 43.6 | 50.69 | 60.01 | 64.36 | 54.63 |
| (MPA) | | | | | | | | |
| Strain at Break | 18 | 15 | 22 | 12 | 27 | 14 | 19 | 15 |
| Max (%) | | | | | | | | |
| Strain at Break | 7 | 6 | 9 | 0 | 11 | 7 | 8 | 4 |
| Min (%) | | | | | | | | |
| Strain at Break | 23 | 12 | 17 | 7 | 20 | 11 | 13 | 9 |
| (%) | | | | | | | | |
| Modulus Max | 2383 | 2391 | 2094 | 1982 | 1960 | 2752 | 2794 | 2702 |
| (MPa) | | | | | | | | |
| Modulus Min | 1964 | 1881 | 1789 | 1447 | 1722 | 2261 | 2534 | 1964 |
| (MPa) | | | | | | | | |
| Modulus | 2125 | 2160 | 1979 | 1717 | 1877 | 2534 | 2627 | 2320 |
| (MPa) | | | | | | | | |

### Example 4

Cellulose acetate pellets were prepared from cellulose acetate flake according to the following process. Cellulose acetate flake was heated overnight at 70° C. to remove moisture from the flake. The cellulose acetate flake was then combined with plasticizer in a high speed mixer. The mixing time varied from 30 seconds to 5 minutes. When mixing time was less than 1 minute, high speed mixing was used. When mixing time was greater than 1 minute, high speed mixing was used for at least the first minute and low speed mixing for the remaining time. The mixed material was wrapped in a plastic bag and stored overnight at room temperature. The mixture was then combined with additives for 30 seconds at low speed. The additives included a combination of bisphenol A propoxylate diglycidyl ether, stearyl 3-(3,5-di-tert-butyl-4-hydroxyphenyl)propionate, and 9,10-dihydro-9-oxa-10-phosphaphenanthrene-10-oxide) and were added to bring the total weight of the sample up to 30 lbs. Samples that had clumped overnight were discarded. The remaining samples were fed through a twin screw feeder and extruded into pellets using a 25 mm extruder. The die temperature was 220° C. and the screw speed was 300 rpm. The feeder was operated in a loss-in-weight mode. The extruder was a twin screw extruder with co-rotating screws. The screw had a modular design. The pellets were then heated in an oven at 70° C. for more than 3 hours to remove moisture. The extruded pellets were then injection molded into tensile bars using an 80 ton injection molder. The tensile bar compositions are shown below in Table 8 for Bars A-F. As shown in Table 8, the tensile bars comprised various plasticizers in various amounts.

TABLE 8
TENSILE BAR COMPOSITIONS

| | Cellulose | | Plasticizer | Plasticizer |
|---|---|---|---|---|
| | Acetate (lbs) | Plasticizer | wt. % | (lbs) |
| Bar A | 27.7 | Triacetin | 20 | 6 |
| Bar B | 20.7 | Triacetin | 30 | 9 |
| Bar C | 23.7 | Triethyl | 20 | 6 |
| | | citrate | | |
| Bar D | 20.7 | Triethyl | 30 | 9 |
| | | citrate | | |
| Bar E | 23.7 | Diethyl | 20 | 6 |
| | | phthalate | | |
| Bar F | 20.7 | Diethyl | 20 | 9 |
| | | phthalate | | |

The color and haze of the composition of Bar F were compared to a commercial cellulose acetate bar obtained from Rotuba®. The color and haze testing was conducted by grinding and pressing the respective samples for two minutes at 25 tons of pressure. The samples were then removed and the color and haze measured using a Hunter Lab Ultrascan colorimeter. The Hunter L, a and b color indices were obtained for each of these samples. The maximum of lightness index L is 100, which could be a perfect reflecting diffuser; the minimum would be zero, which would be black. The color indices a and b axes have no specific numerical limits. Positive a is red, negative a is green. Positive b is yellow and negative b is blue. The results are shown in Table 9.

TABLE 9
COLOR AND HAZE MEASUREMENTS

| | L | a | b | Haze (%) |
|---|---|---|---|---|
| Bar F | 94.70 | −0.59 | 5.16 | 8.75 |
| Comparative Bar 1 | 93.95 | −0.95 | −1.55 | 4.00 |

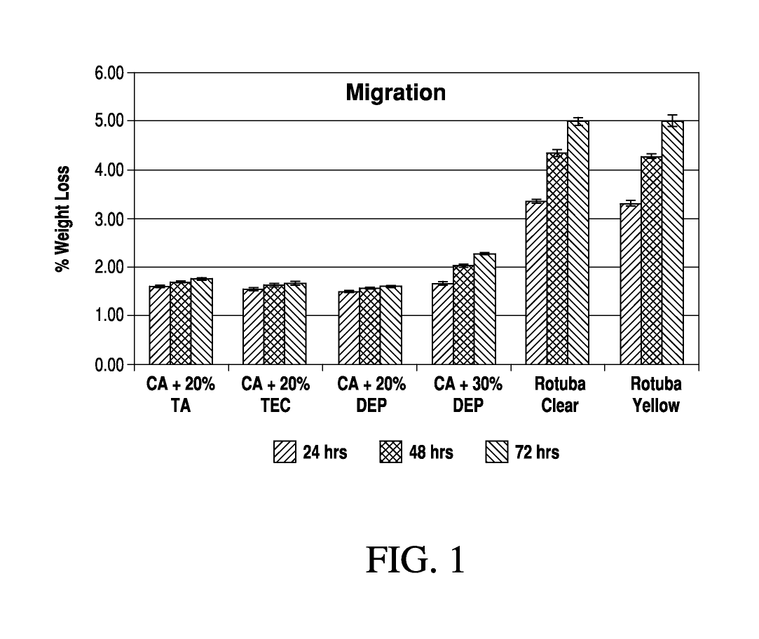

Bars A, C, E and F were compared to bars formed from two commercial grade cellulose acetate bars, Rotuba clear and Rotuba yellow. The results of the flex modulus, tensile modulus, stress at break, strain at break and impact strength are shown in Table 10. The plasticizer migration results are shown in FIG. 1. Plasticizer migration was measured by heating Bars A, C, E, F, Rotuba clear and Rotuba yellow to 80° C.

TABLE 10
BAR PROPERTIES

| | | | | | Robuta | Robuta |
|---|---|---|---|---|---|---|
| | Bar A | Bar C | Bar E | Bar F | Clear | Yellow |
| Flex Modulus | 2371 | 3247 | 3659 | 2797 | 1495 | 1452 |
| (MPa) | | | | | | |
| Tensile | 3210 | 3215 | 3358 | 2484 | 1377 | 1372 |
| Modulus (MPa) | | | | | | |
| Stress at | 61.36 | 60.77 | 65.73 | 44.63 | 22.45 | 22.01 |
| Break (MPA) | | | | | | |
| Strain at | 8.02 | 8.45 | 9.44 | 11.94 | 31.53 | 33.26 |
| Break (%) | | | | | | |
| Impact Strength | 6.9 | 5.7 | 7.1 | 10.7 | 15.8 | 14.8 |
| (Charpy) | | | | | | |
| (kJ/m²) | | | | | | |
| Impact Strength | 7.2 | 6.2 | 7.1 | 11.5 | 15.8 | 14.3 |
| (Izod) (kJ/m²) | | | | | | |

While the invention has been described in detail, modifications within the spirit and scope of the invention will be readily apparent to those of skill in the art. It should be understood that aspects of the invention and portions of various embodiments and various features recited herein and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. A process for manufacturing table tennis balls, comprising:
(a) mixing cellulose acetate and a plasticizer to form a mixture;
(b) melt extruding the mixture in a film die to form an extruded sheet;
(c) soaking the extruded sheet in a solvent to form a soaked sheet;
(d) cutting a plurality of coupons from the soaked sheet;
(e) thermoforming the coupons into hemispheres; and
(f) adhering pairs of hemispheres to form the table tennis balls.

2. The process of claim 1, wherein the solvent is selected from the group consisting of water, one or more alcohols, and combinations thereof.

3. The process of claim 1, wherein the plasticizer is selected from the group consisting of triacetin, tributyl citrate, triethyl citrate, dimethyl phthalate, diethyl phthalate, bornan-2-one, PEG-DGE, PPG-DGE, tributyl phosphate, and combinations thereof.

4. The process of claim 1, wherein the mixture further comprises an antioxidant selected from the group consisting of stearyl 3-(3,5-di-tert-butyl-4-hydroxyphenyl) propionate, bis(2,4-dicumylphenyl)pentaerythritol diphosphite, tris(2,4-di-tert-butylphenyl)phosphite, bisphenol A propoxylate diglycidyl ether, 9,10-dihydroxy-9-oxa-10-phosphaphenanthrene-10-oxide, and combinations thereof.

5. The process of claim 1, wherein the mixture further comprises a lubricant selected from the group consisting of epoxidized soybean oil, epoxidized polypropylene oxide, epoxidized PPO-PEO, and combinations thereof.

6. The process of claim 1, wherein the mixture further comprises a colorant selected from the group consisting of titanium oxide, barium sulfate, iron oxide, nickel titanate, benzimidazolone orange gl, solvent orange 60, orange dyes, a combination of red and yellow dyes, and combinations thereof.

7. The process of claim 1, wherein the mixture is formed by mixing cellulose acetate flake with the plasticizer in a high speed mixer optionally with one or more additives.

8. The process of claim 1, wherein the mixture is formed by mixing cellulose acetate powder with the plasticizer in a high speed mixer optionally with one or more additives.

9. The process of claim 1, wherein the melt extruding is performed at a temperature less than or equal to 220° C.

10. The process of claim 1, wherein the mixture comprises from 60 to 75 wt. % cellulose acetate and from 25 to 35 wt. % plasticizer.

11. The process of claim 1, wherein the cellulose acetate has a degree of substitution from 2.1 to 2.9.

12. The process of claim 1, wherein the cellulose acetate has a molecular weight from 40,000 to 80,000 amu.

13. The process of claim 1, wherein the extruded sheet is soaked in water for 1 to 24 hours.

14. A table tennis ball prepared according to the process of claim 1.

15. A process for manufacturing a table tennis ball, comprising:
(a) providing pellets comprising cellulose acetate, a plasticizer, and optionally one or more additives;
(b) injection molding the pellets into a die to form hemispheres; and
(c) adhering pairs of hemispheres to form table tennis balls;
wherein the pellets are formed by melt extrusion or solvent casting.

16. The process of claim 15, wherein the plasticizer is selected from the group consisting of triacetin, tributyl citrate, triethyl citrate, dimethyl phthalate, diethyl phthalate, bornan-2-one, PEG-DGE, PPG-DGE, tributyl phosphate, and combinations thereof.

17. The process of claim 15, wherein the mixture is formed by mixing cellulose acetate flake with the plasticizer in a high speed mixer optionally with one or more additives.

18. The process of claim 15, wherein the mixture is formed by mixing cellulose acetate powder with the plasticizer in a high speed mixer optionally with one or more additives.

19. A table tennis ball prepared according to the process of claim 15.

20. Melt Extruding and injection molding a mixture to form a table tennis ball, the mixture comprising cellulose acetate having a degree of substitution from 2.1 to 2.9, a plasticizer, and optionally one or more additives.
